(19) United States
(12) Patent Application Publication
(10) Pub. No.: US 2007/0128509 A1
(43) Pub. Date: Jun. 7, 2007

(54) PRODUCING SODIUM BOROHYDRIDE WITH HIGH ENERGY EFFICIENCY AND RECYCLES OF BY-PRODUCT MATERIALS

(76) Inventor: Zongxuan Hong, Houston, TX (US)

Correspondence Address: Zongxuan Hong, 4043 Elm Crest Trl., Houston, TX, 77059, US

(21) Appl. No.: 11/563,605

(22) Filed: Nov. 27, 2006

Related U.S. Application Data
(60) Provisional application No. 60/742,746, filed on Dec. 5, 2005.

(51) Int. Cl. H01M 6/20; C01B 6/21; C01B 35/00

(52) U.S. Cl. 429/104; 423/286

(57) ABSTRACT

A method for synthesizing sodium borohydride compound with reduced energy usage and recycles of by-product materials involved in the application and synthesis processes of sodium borohydride is disclosed. The method utilizes a sodium-sulfur electrochemical cell flow system for synthesizing sodium metal and incorporates the sodium metal produced in the commercial sodium borohydride synthesis processes known in prior arts, for example, the “Schlesinger process”. Furthermore, the by-product materials involved in the application and synthesis of sodium borohydride are recycled through a series of processes.

### FIELD OF INVENTION

The present invention relates to processes for synthesizing sodium borohydride compound with high efficiency in energy usage, particularly to utilizing a sodium-sulfir electrochemical cell flow system for synthesizing sodium metal, which is further used in the commercial sodium borohydride synthesis processes known in prior arts. The present invention also relates to incorporating recycles of by-product materials in the application and synthesis of sodium borohydride in the synthesis processes.

### BACKGROUND OF INVENTION

Sodium borohydride is an important specialty chemical that has been used in pharmaceutical, chemical, and pulp and paper industries. Recently, sodium borohydride is being used as an energy source in fuel cell and battery applications. For example, U.S. Pat. 6,534,033, disclosed a method using sodium borohydride as a feed to generate hydrogen for hydrogen fuel cell. U.S. Pat. 6,497,973, disclosed a method using sodium borohydride as an anode in electroconversion cell. US Patent application 20050175877, disclosed a method using sodium borohydride as a reducing agent for continuous regeneration of the anode in a metal-air battery system. In general, sodium borohydride generates energy through its reduction process, in which sodium borohydride is oxidized to form sodium borate.

In prior art, sodium borohydride is commercially produced by the “Schlesinger process”, which comprises steps of:
(i) converting boric acid from reaction with methanol into tri-methoxy borate (B(OCH₃)₃);
(ii) converting sodium metal from reaction with hydrogen into sodium hydride;
(iii) producing sodium borohydride from reaction of sodium hydride with tri-methoxy borate.

The chemical reactions are shown in Equations 1-3.
H₃BO₃+3CH₃OH->B(OCH₃)₃+3H₂O (1)
2Na+H₂->2NaH (2)
4NaH+B(OCH₃)₃->NaBH₄+3NaOCH₃ (3)

In this process, the cost of sodium metal is a major factor in the overall cost of sodium borohydride production. Sodium is commercially prepared by electrolysis from molten sodium chloride using “Downs cell”. The process, shown as in reaction 4, is carried at around 600° C. in a molten mixture of calcium chloride and sodium chloride. The addition of calcium chloride to sodium chloride lowers the melting point of the mixture to 600° C. from the melting point of sodium chloride at 800° C. This process consumes lots of energy with theoretical enthalpy change of 196 kcal for every 2 moles of sodium produced at about 600° C. Carrying out the process at high temperature also adds more expense with respect to heating cost and facility requirements. The cost of production of sodium is mainly from the high-energy cost, as well as the high operating cost.
2NaCl->2Na+Cl₂ (4)

In addition, if large quantities of sodium borohydride would be used as an energy source, the current commercial process, such as “Schlesinger process”, would produce large quantities of waste by-products, for example, sodium methoxide. Additional expense is required to dispose these by-products.

Because of the low energy efficiency in the current commercial processes and other operational issues associated with the processes, several alternative routes to synthesize sodium borohydride are studied to improve the energy efficiency. For example, U.S. Pat. No. 6,670,444, disclosed a method using disproportionation of diborane with small hard Lewis bases, such as sodium methoxide and sodium hydroxide, to synthesize sodium borohydride. U.S. Pat. No. 6,586,563, disclosed a method using reaction of borane or diborane with base compounds, such as sodium carbonate, to synthesize sodium borohydride. U.S. Pat. No. 6,524,542, disclosed a method producing boron halides, and then converting boron halides into diborane for sodium borohydride synthesis. The above methods all involve diborane in the production, which is a material difficult to handle in commercial processes. In general, a commercial viable method with high energy efficiency is still not available.

In this patent, a commercial viable method in synthesizing sodium borohydride with significant energy efficiency improvement is disclosed. In addition, the byproducts involved in the application and synthesis of sodium borohydride are recycled, and incorporated back into the synthesis processes to further improve the economy of sodium borohydride production.

### SUMMARY OF THE INVENTION

The present invention discloses a process synthesizing sodium borohydride compound with reduced energy usage using a sodium-sulfur flow electrochemical cell system to produce sodium metal and incorporating the sodium metal produced into commercial sodium borohydride synthesis known to prior arts.

In the present invention, a sodium-sulfur electrochemical cell flow system is used in producing sodium metal during the electrochemical cell recharging process. The sodium-sulfur electrochemical cell flow system comprises of an anode compartment, a flow system connected to said anode compartment for input and output of anode material, a cathode compartment, a flow system connected to said cathode compartment for input and output of cathode material, and a solid electrolyte membrane that separates said anode compartment and said cathode compartment.

The sodium-sulfur electrochemical cell flow system is used to produce sodium metal during the electrochemical cell flow system recharging process, wherein, the electricity passes through the electrochemical cell, and sodium ions from cathode transfer through the solid electrolyte membrane to combine with electrons to form sodium metal at the anode, and said sodium metal formed is continuously removed from the anode compartment by said anode flow system, and simultaneously cathode material is continuously fed into cathode compartment by said cathode flow system.

In one embodiment of the present invention, the anode material is sodium metal.

In another embodiment of the present invention, the cathode material is sodium polysulfide.

In another embodiment of the present invention, the solid electrolyte membrane is an ion-conductive electrolyte membrane that transfers sodium ion. Beta-aliumina electrolyte membrane is a type of ion-conductive solid electrolyte membrane.

In another embodiment of the present invention, the sodium-sulfur electrochemical cell flow system is operated at a temperature range of 200° C. to 600° C., preferably 250° C. to 450° C., wherein, said anode material and cathode material are at molten state.

The present invention also discloses a process that recycles the by-product materials involved in the application and synthesis process of sodium borohydride, wherein, the process comprises of:
(a) synthesize sodium metal using a sodium-sulfur electrochemical cell flow system during the electrochemical cell recharging process;
(b) incorporate said sodium metal produced by said sodium-sulfur electrochemical cell flow system in commercial sodium borohydride synthesis process known to prior arts as “Schlesinger process”;
(c) react sodium borate with hydrogen sulfide to produce boric acid and sodium sulfide;
(d) react sodium methoxide with hydrogen sulfide to produce sodium sulfide and methanol;
(e) react said sodium sulfide produced in (c) or (d) with sulfur to form sodium polysulfide, or with sodium polysulfide with low sodium content to form sodium polysulfide with higher sodium content;
(f) react sodium borate with carboxylic acid to produce boric acid and sodium carbonate;
(g) incorporate said boric acid produced in (c) or (f) in commercial sodium borohydride synthesis process known to prior arts as “Schlesinger process” in (b).

In one embodiment of the present invention, sodium borate is the discharged by-product in the application of sodium borohydride in its reduction process. The reaction of sodium borate with hydrogen sulfide to form sodium sulfide and boric acid is operated at temperature in the range of 100° C. to 400° C., at pressure in the range of 10 atm to 100 atm. The reaction of sodium borate with carboxylic acid to form sodium carbonate and boric acid is operated at temperature in the range of 100° C. to 600° C., at pressure in the range of 1 atm to 100 atm.

In another embodiment of the present invention, said sodium sulfide produced in the recycle processes is used for producing the cathode material of the sodium-sulfur electrochemical cell flow system, wherein, sodium sulfide reacts with sulfur to produce sodium polysulfide, or sodium sulfide reacts with used cathode material, that is sodium polysulfide with less sodium content, to produce sodium polysulfide with higher sodium content. The reaction is operated at temperature in the range of 100° C. to 600° C., at pressure in the range of 1 atm to 100 atm.

In another embodiment of the present invention, sodium methoxide is a by-product in sodium borohydride synthesis by “Schlesinger process”. Sodium methoxide is reacted with hydrogen sulfide to form sodium sulfide and methanol. The sodium sulfide and methanol are separated. The sodium sulfide is used for producing the cathode material of the sodium-sulfur electric cell. The methanol is used in reaction with boric acid to form tri-methoxy borate. The reaction is operated at temperature in the range of −20° C. to 200° C., at pressure in the range of 1 atm to 100 atm.

In another embodiment of the present invention, the use of hydrogen sulfide can be incorporated into hydrotreating process in refinery process.

The processes of this invention may also be integrated into an overall regeneration scheme of sodium borohydride production from boron-containing ores.

### BRIEF DESCRIPTION OF THE DRAWINGS

The drawing constitutes a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic drawing of a sodium-sulfur electrochemical cell flow system having features of this invention, wherein, the sodium-sulfur electrochemical cell flow system comprises of: (i) an anode compartment, (ii) a flow system connected to said anode compartment for input and output of the anode material, (iii) a cathode compartment, (iv) a flow system connected to said cathode compartment for input and output of the cathode material, and (v) a solid electrolyte membrane that separate said anode compartment and cathode compartment.

### DETAILED DESCRIPTION OF THE INVENTION

The present invention discloses a process synthesizing sodium borohydride compound with reduced energy usage using a sodium-sulfur electrochemical cell flow system to produce sodium metal and incorporating the sodium metal produced into commercial sodium borohydride synthesis known to prior arts.

The sodium-sulfur electrochemical cell flow system comprises of an anode compartment, a flow system connected to the anode compartment for input and output of anode material, a cathode compartment, a flow system connected to the cathode compartment for input and output of cathode material, and a solid electrolyte membrane that separates the anode compartment and cathode compartment.

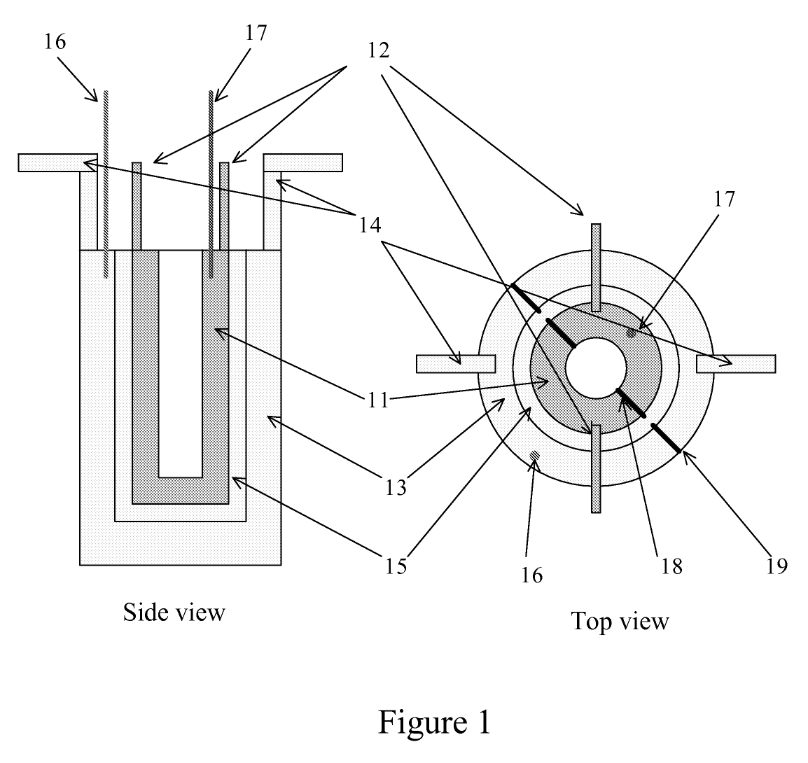

FIG. 1 shows a schematic drawing of the sodium-sulfur electrochemical cell flow system. 11 is the anode compartment. 12 is the flow system connected to the anode compartment for input and output of anode material. 13 is the cathode compartment. 14 is the flow system connected to the cathode compartment for input and output of cathode material. 15 is the solid electrolyte membrane that separates the anode compartment and the cathode compartment. 16 is the cathode electrode input from power supply. 17 is the anode electrode input from power supply. 18 is the block plate in the anode compartment. 19 is the block plate in the cathode compartment.

The sodium-sulfur electrochemical cell flow system is used to produce sodium metal during the electrochemical cell flow system recharging process. The anode of the sodium-sulfur electrochemical cell flow system is sodium metal, and the cathode of the sodium-sulfur electrochemical cell flow system is sodium polysulfide. When electricity passes through the sodium-sulfur electrochemical cell in the recharging process, sodium ions from sodium polysulfide, that is cathode, transfer through the electrolyte membrane, and combine with electrons at anode to form sodium metal.

The anode sodium metal produced is then continuously removed from the anode compartment by the anode flow system, while the cathode sodium polysulfide is continuously fed into the cathode compartment.

This process can be represented in one case as shown in Equation 5. Other electrochemical reaction for the sodium-sulfur electrochemical cell is similar in nature as in Equation 5.
2Na₂S₂->2Na+2NaS₂ (5)

This process consumes much less energy with theoretical enthalpy change of 96 kcal for every 2 moles of sodium produced at about 300° C. The theoretical energy consumption is less than 50% of that for commercial electrolysis of sodium chloride of 196 kcal. The electrochemical recharging process of sodium-sulfur electrochemical cell is also more efficient with about 85% of efficiency than the electrolysis process of sodium chloride with only about 60% of efficiency.

In addition, the sodium-sulfur electrochemical cell flow system is usually operated at about 300° C., at which temperature the sodium and sodium polysulfide are molten. This temperature is also much less than that of molten sodium chloride and calcium chloride mixture of about 600° C. The much lower operating temperature not only saves heating energy, but also saves expenses of facilities for high temperature operation.

The sodium metal produced can then be incorporated into commercial processes of sodium borohydride synthesis known to prior arts, for example, the “Schlesigner process”.

The present invention also discloses a process that recycles the by-product materials involved in the application and synthesis process of sodium borohydride.

Energy is released from sodium borohydride via its reduction process and sodium borohydride is discharged into sodium borate.

In this invention, sodium borate is reacted with hydrogen sulfide to form boric acid and sodium sulfide as shown in Equation 6. This reaction is favorable at high pressure. The high-pressure operation is in consistence with the requirement of industrial process, and enhances the reaction rate. Boric acid formed can be used to produce tri-methoxy borate (B(OCH₃)₃), which is a feed in sodium borohydride synthesis. Sodium sulfide can be used to produce sodium polysulfide, which is the cathode material in sodium synthesis.
2NaBO₂H₂O+H₂S->Na₂S+2H₃BO₃ (6)

This process is operated at temperature in the range of 100° C. to 400° C., at pressure in the range of 10 atm to 100 atm.

Sodium sulfide can be reacted with sulfur to form sodium polysulfide, depending on the stoichiometry of sulfur and sodium sulfide as shown in the cases in Equations 7 and 8.
Na₂S+S->Na₂S₂ (7)
Na₂S+2S->Na₂S₃ (8)

This process is operated at temperature in the range of 100° C. to 600° C., at pressure in the range of 1 atm to 100 atm.

Sodium sulfide can also be reacted with sodium polysulfide to form sodium polysulfide with higher sodium content, depending on the stoichiometry of sulfur polysulfide and sodium sulfide as shown in the case in Equation 9.
Na₂S+Na₂S₃->2Na₂S₂ (9)

This process is operated at temperature in the range of 100° C. to 600° C., at pressure in the range of 1 atm to 100 atm.

In this invention, the by-product sodium methoxide in “Schlesinger process” for sodium borohydride synthesis is reacted with hydrogen sulfide to form sodium sulfide and methanol, as shown in Equation 10.
2NaOCH₃+H₂S->Na₂S+2CH₃0H (10)

The sodium sulfide is a feed to produce sodium polysulfide as discussed above. The methanol is a feed to produce tri-methoxy borate.

This reaction is operated at temperature in the range of −20° C. to 200° C., at pressure in the range of 1 atm to 100 atm.

Alternatively, sodium borate is reacted with carboxylic acid to form boric acid and sodium carbonate as shown in Equation 11.
2NaBO₂.H₂O+H₂CO₃->Na₂CO₃+2H₃BO₃ (11)

Borate used in the overall sodium borohydride synthesis can also be obtained from other routes known in prior arts.

It should be understood that various changes and modifications to the preferred embodiments herein will be apparent to those skilled in the art. Such changes and modifications can be made without departing from the concept and scope of this invention and without diminishing its attendant advantages. It is therefore intended that such changes and modifications be covered by the appended claims.

What is claimed is:

1. A process for producing sodium borohydride compound, wherein the process comprises of a sodium-sulfur electrochemical cell flow system synthesizing sodium metal during electrochemical cell recharging process, and said sodium metal produced being incorporated in the sodium borohydride synthesis in the commercial processes that use sodium metal;
said sodium-sulfur electrochemical cell flow system comprises of (i) an anode compartment, (ii) a flow system connected to said anode compartment for input and output of anode material, (iii) a cathode compartment, (iv) a flow system connected to said cathode compartment for input and output of cathode material, and (v) a solid electrolyte membrane that separates said anode compartment and cathode compartment.

2. The sodium-sulfur electrochemical cell flow system of claim 1 is used to produce sodium metal during the electrochemical cell flow system recharging process, wherein, the electricity is passed through said sodium-sulfur electrochemical cell, and sodium ions from cathode transfer through the solid electrolyte membrane to combine with electrons to form sodium metal at the anode, and said sodium metal is continuously removed from the anode compartment by the anode flow system, and simultaneously cathode material is continuously fed into the cathode compartment by the cathode flow system.

3. The anode material of claim 1 is sodium metal.

4. The cathode material of claim 1 is sodium polysulfide.

5. The solid electrolyte membrane of claim 1 is an ion-conductive electrolyte membrane that transfers sodium ion.

6. The solid electrolyte membrane of claim 1 is beta-alumina electrolyte membrane.

7. The sodium-sulfur electrochemical cell flow system of claim 2 is operated at temperature of 200° C. to 600° C., preferably 250° C. to 450° C., wherein, said anode material and cathode material are molten.

8. The commercial process for synthesizing sodium borohydride of claim 1 is known as prior art “Schlesinger process”.

9. The commercial process for synthesizing sodium borohydride of claim 1 is known as prior art “Bayer process”.

10. A process for producing sodium borohydride compound, comprising of:
(a) synthesize sodium metal using a sodium-sulfur electrochemical cell flow system during electrochemical cell recharging process;
(b) incorporate said sodium metal produced in the sodium borohydride synthesis known as prior art “Schlesinger process”;
(c) react sodium borate with hydrogen sulfide to produce boric acid and sodium sulfide;
(d) react sodium methoxide with hydrogen sulfide to produce sodium sulfide and methanol;
(e) react said sodium sulfide in (c) and (d) with sulfur to form sodium polysulfide, or with sodium polysulfide with low sodium content to form sodium polysulfide with higher sodium content;
wherein, said sodium-sulfur electrochemical cell flow system comprises of an anode compartment, a flow system connected to said anode compartment for input and output of anode material, a cathode compartment, a flow system connected to said cathode compartment for input and output of cathode material, and a solid electrolyte membrane that separates said anode compartment and cathode compartment.

11. Sodium borate of claim 10 is the discharged by-product from the application of sodium borohydride after its reduction process.

12. Sodium methoxide of claim 10 is the by-product from “Schlesinger process”, wherein sodium metal reacts with tri-methoxy borate to form sodium borohydride and sodium methoxide.

13. Sodium polysulfide with low sodium content of claim 10 is the used cathode material of sodium-sulfur electrochemical cell flow system after sodium synthesis.

14. Sodium polysulfide with higher sodium content of claim 10 is used as feed for cathode material of sodium-sulfur electrochemical cell flow system.

15. Methanol produced as in claim 10 is recycled to be used in “Schlesinger process” to produce tri-methoxy borate from reaction with boric acid.

16. The process according to claim 10, wherein, the reaction of sodium borate with hydrogen sulfide to produce boric acid and sodium sulfide is operated at temperature in the range of 100° C. to 400° C., at pressure in the range of 10 atm to 100 atm.

17. The process according to claim 10, wherein, the reaction of sodium sulfide with sulfur to form sodium polysulfide, or the reaction of sodium sulfide with sodium polysulfide with low sodium content to form sodium polysulfide with higher sodium content is operated at temperature in the range of 100° C. to 600° C., at pressure in the range of 1 atm to 100 atm.

18. The process according to claim 10, wherein, the reaction of sodium methoxide with hydrogen sulfide to form sodium sulfide and methanol is operated at temperature in the range of −20° C. to 200° C., at pressure in the range of 1 atm to 100 atm.

19. The use of hydrogen sulfide in claim 10 is incorporated into hydrotreating process in refinery process.
